(19) United States
(12) Patent Application Publication
(10) Pub. No.: US 2015/0104777 A1
(43) Pub. Date: Apr. 16, 2015

(54) CONTEXT-SENSITIVE AND LOCATION-AWARE ADAPTIVE LEARNING TO IMPROVE TEST EFFECTIVENESS

(71) Applicant: Texas Instruments Incorporated, Dallas, TX (US)

(72) Inventors: Harshal S. Chhaya, Plano, TX (US); Robert Charles Wellman Jenks, McKinney, TX (US)

(21) Appl. No.: 14/515,274

(22) Filed: Oct. 15, 2014

Related U.S. Application Data
(60) Provisional application No. 61/891,126, filed on Oct. 15, 2013.

(51) Int. Cl. G09B 7/00

(52) U.S. Cl. CPC G09B 7/00; H04W 4/02
USPC 434/322

(57) ABSTRACT

A context-sensitive and location-aware adaptive method and device. The method includes determining user's information relating at least one of context or location, adaptively altering at least one of data and image based on the determined user's information, and presenting the altered information.

### CROSS REFERENCES TO RELATED APPLICATIONS

This application claims priority from U.S. Provisional Patent Application No. 61/891,126 filed on Oct. 15, 2013, which is hereby incorporated by reference in its entirety.

### BACKGROUND OF THE INVENTION

1. Field of the Invention

Embodiments of the present invention generally relate to a method and apparatus for context sensitive and location-aware adaptive learning to improve test effectiveness using user information.

2. Description of the Related Art

Many computer-based tests change the difficulty of the questions. However, they do not adapt the content to match the student's location or socio-economic context. Existing “adaptive learning” solutions change the difficult of questions based on the student's ability to answer previous questions. This does not take into account the very important possibility that a student may have had a wrong answer because they had difficulty comprehending the question, not because they did not know how to solve the problem.

Since a student is likely to answer a question incorrectly due to comprehension problems even if they know the topic of the test, the tests are less effective. Therefore, there is a need to enhance adaptive learning using user parameters.

### SUMMARY OF THE INVENTION

Embodiments of the present invention relate to a context-sensitive and location-aware adaptive method and device. The method includes determining user's information relating at least one of context or location, adaptively altering at least one of data and image based on the determined user's information, and presenting the altered information.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of a context-sensitive and location-aware adaptive system;

FIG. 2 is an embodiment of a block diagram of a context-sensitive and location-aware adaptive device; and

FIG. 3 is an embodiment of a flow diagram depicting a method for a context-sensitive and location-aware adaptive device.

### DETAILED DESCRIPTION

This invention relates to a context-sensitive and location-aware adaptive device. The device is capable of altering or improving content of materials displayed based on user's location or context. For example such a device may be a calculator used in an exam. Wherein the questions resented to the student by the calculator are altered based on the users' locations and context.

For example, rather than ask a student in South Texas about “inches of snow” in a question about total accumulation after X hrs of snowfall at rate of Y in/hr, it is better to ask about “inches of rain”. This is more relevant to the student's life experience. The math calculation, for example, remains the same. However, the student can relate better to the question and not have to puzzle over the content of the question. This will help test students for math without introducing confusing factors, which may affect test performance due to confusion and comprehension problems.

In one embodiment, this process is performed automatically on the backend based on the student profile, location or school profile. The “location” is just an example and you could potentially use any student/school characteristic to tailor the test. In another embodiment, the device is GPS capable and determines the user's data based on GPS determined location.

In one embodiment, cultural markers are used to make the questions and content more relevant. In such a case, the language is automatically selected based on user's data. Also, location may be used to present culturally acceptable questions. For example different colors have very different meanings in different cultures, i.e. the US conventions of “Red is Bad” and “Green is Good” don't apply in other countries; and in some cultures using a pig may not a good animal to be a girl's friend in a book etc. The rules for displaying an image or a question may be derived from a student's location, their profile or a combination of the two. As a result, the student is capable of focusing on the actual problem without dealing with “comprehension” barrier. Also, such a solution would allow a device to be adaptive and alter its display of data or images based on several different parameters—location, cultural markers etc. Such a process, in one embodiment, is transparent to the users. Customized tests could be printed based on the specific parameters and administered. The same mathematical questions might have different descriptions in Boston when compared to Orlando.

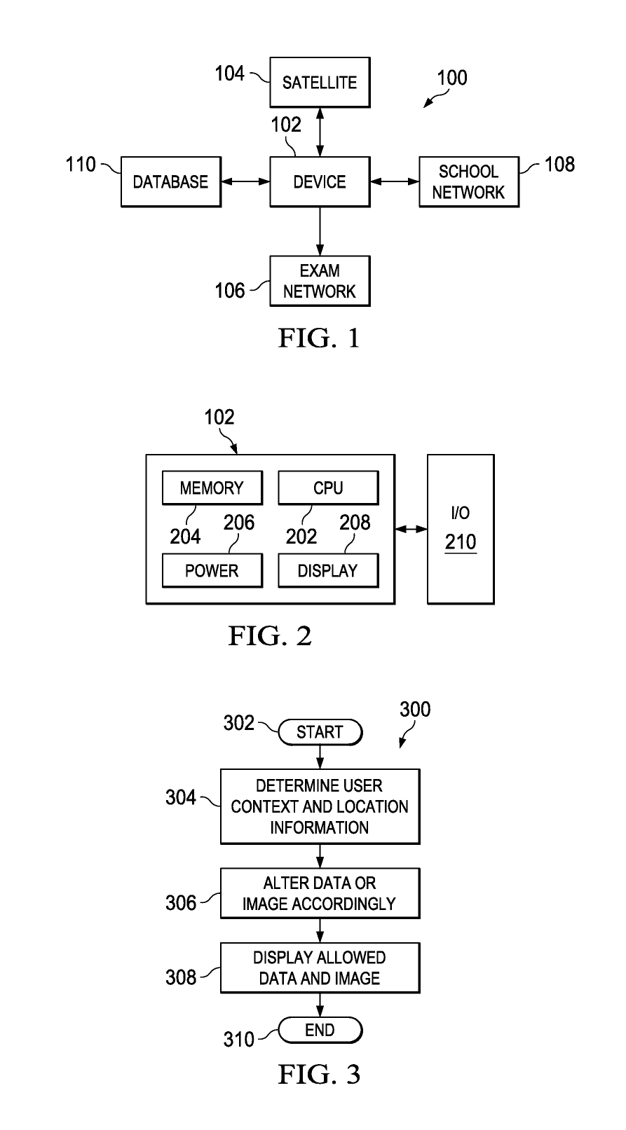

FIG. 1 is an embodiment of a context-sensitive and location-aware adaptive system 100. The context-sensitive and location-aware adaptive system 100 includes a context-sensitive and location-aware adaptive device 102, satellite 104, exam network 106, and school network 108. The context-sensitive and location-aware adaptive device 102 is better described in FIG. 2. The context-sensitive and location-aware adaptive device may communicate with one or all of such items.

FIG. 2 is an embodiment of a block diagram of a context-sensitive and location-aware adaptive device 102. The context-sensitive and location-aware adaptive device 102 includes a CPU 202, a memory 204, power module 206, display 208 and I/O module 210. The CPU 202 may include any suitable combination of software, firmware, and hardware. The CPU 202 may include one or more digital signal processors (DSPs), microprocessors, discrete logic, application specific integrated circuits (ASICs), field-programmable gate arrays (FPGAs), etc. The memory 204 may be internal or external to the context-sensitive and location-aware adaptive device 102 and may be a read only, write only, read/write, transitory, non-transitory and the likes. The power 206 may be electric, battery or solar power. The Input/output (I/O) module 210 may be internal, external or coupled to the device 102. The context-sensitive and location-aware adaptive device 102 performs the method 300, described herein below.

FIG. 3 is an embodiment of a flow diagram depicting a method 300 for a context-sensitive and location-aware adaptive device. The method 300 starts at step 302 and proceeds to step 304, wherein the method 300 determines the user's context and location information. The method 300 proceeds to step 306 to alter data or image according to the determined user context and location information. At step 308, the method 300 displays the altered data and/or image. The method 300 ends at step 310.

While the foregoing is directed to embodiments of the present invention, other and further embodiments of the invention may be devised without departing from the basic scope thereof, and the scope thereof is determined by the claims that follow.

What is claimed is:

1. A context-sensitive and location-aware adaptive device, comprising:
memory for archiving at least one of data or an image; and
processor coupled to the memory configured to perform a context-sensitive and location-aware adaptive method, wherein the method adaptively alters at least one of data and an image based on user's at least one of context or location.

2. The device of claim 1 wherein the at least one of data and image are used for testing purposes.

3. The device of claim 1, wherein the context-sensitive and location-aware adaptive device is at least one of a handheld device and a calculator.

4. The device of claim 1, wherein the user's at least one of context or location are determined via at least one of a user profile, metadata, satellite, user input, and network data.

5. A context-sensitive and location-aware adaptive method, comprising:
determining user's information relating at least one of context or location;
adaptively altering at least one of data and image based on the determined user's information; and
presenting the altered information.

6. The method of claim 5, wherein the at least one of data and image are used for testing purposes.

7. The method of claim 5, wherein the context-sensitive and location-aware adaptive device is at least one of a handheld device and a calculator.

8. The method of claim 5, wherein the user's at least one of context or location are determined via at least one of a user profile, metadata, satellite, user input, and network data.
